(19) United States
(12) Patent Application Publication
(10) Pub. No.: US 2026/0111702 A1
(43) Pub. Date: Apr. 23, 2026

(54) SYSTEMS AND METHODS FOR MONITORING PROPERTIES OF A PHYSICAL RESERVOIR COMPUTER (PRC) AND MITIGATING PERFORMANCE DEGRADATION

(71) Applicant: Toyota Motor Engineering & Manufacturing North America, Inc., Plano, TX (US)

(72) Inventors: Akila C. Ganlath, Fremont, CA (US); Rohit Gupta, Santa Clara, CA (US)

(73) Assignees: Toyota Motor Engineering & Manufacturing North America, Inc., Plano, TX (US); Toyota Jidosha Kabushiki Kaisha, Toyota-shi Aichi-ken (JP)

(21) Appl. No.: 18/922,542

(22) Filed: Oct. 22, 2024

(51) Int. Cl. G06N 3/044

(52) U.S. Cl. CPC G06N 3/044

(57) ABSTRACT

Systems, methods, and other embodiments described herein relate to monitoring the deviation of system properties for a PRC from environmental factors and mitigating the deviation. In one embodiment, a method includes monitoring system properties of a PRC that predicts a parameter for a vehicle environment during a task, and the PRC is associated with a machine learning (ML) model that outputs the parameter. The method also includes predicting a PRC state and a reservoir drift using the system properties. The method also includes mitigating PRC degradation associated with the reservoir drift by switching from the PRC to a computation framework, and the computation framework calculates the parameter using the ML model.

### TECHNICAL FIELD

The subject matter described herein relates, in general, to monitoring system properties of a physical reservoir computer (PRC), and, more particularly, to monitoring deviation of the system properties for a PRC from environmental factors and mitigating the deviation.

### BACKGROUND

Processors execute tasks using various computational architectures and models. For example, an application-specific integrated circuit (ASIC) is a chip tailored to perform a specific task more efficiently than a general-purpose processor. A graphics processing unit (GPU) accelerates the rendering of images and videos by performing parallel processing tasks efficiently improving digital computations that are graphics-intensive such as object detection. Another computer architecture uses hardware reservoirs that is one of mechanical-based (e.g., pendulums) and electronics-based (e.g., resistors, capacitors, etc.) for processing computations. Furthermore, a physical reservoir computer (PRC) is an analog computer that accurately executes a task spanning a time period that is extended. A PRC is especially efficient and accurate for real scenarios that are non-linear and dynamic. Therefore, systems can utilize digital and analog architectures to execute different tasks depending on applications.

In various implementations, a PRC replicates a physical embodiment of a machine learning (ML) model using an analog form. The PRC can estimate parameters associated with a task for various applications and environments. For example, a PRC embodies a learning network that detects an object involving a vehicle environment as an application. Here, the PRC classifies elements within a scene for detecting objects that are obstacles. However, disturbances germane to a vehicle environment and other environments can negatively impact PRC performance. For instance, dynamic changes in moisture and temperatures effect system properties for a PRC that decrease accuracy. Therefore, a PRC encounters difficulties maintaining performance and accuracy in various environments (e.g., a driving environment).

### SUMMARY

In one embodiment, example systems and methods relate to monitoring deviation of system properties for a physical reservoir computer (PRC) from environmental factors and mitigating the deviation. Here, a reservoir can be a subsystem having a fixed network of interconnected nodes that collectively and dynamically transform input signals held in a location into complex activity patterns. As such, a PRC can realize the reservoir as a physical system having non-linear dynamics internally that are complex. In various implementations, systems implement a PRC as an analog computer for machine learning (ML) and mathematical computations that are complex. A PRC in ML applications (e.g., a neural network (NN)) can exhibit performance gains over more traditional computing (e.g., a graphics processing unit (GPU), application-specific integrated circuit (ASIC), etc.) associated with training and inference from being a physical embodiment of a ML model. For instance, certain PRCs mimic a recurrent neural network (RNN) architecture beneficial for predictions involving spatiotemporal signals (e.g., natural language prediction (NLP), vehicle dynamics, etc.) that are inputted. Nevertheless, environmental perturbations (e.g., humidity changes, temperature, etc.) affect performance advantages from the physical nature underlying PRCs and degrade PRC system properties. As such, physical phenomena can offset performance gains over silicon computing for certain operating environments. Thus, systems implementing a PRC for executing predictions and estimates using a ML model have challenges sustaining performance and accuracy in diverse physical environments (e.g., a driving environment), thereby reducing benefits associated with PRCs.

Therefore, in one embodiment, an estimation system monitors a PRC performing a task and improves accuracy by measuring system properties reliably for operating environments and computing functions that vary. Here, the system properties can be one of a forecast horizon, an echo state, and a Lyapunov coefficient associated with the PRC. In one approach, the estimation system integrates the PRC for a task within a vehicle environment that involves processing of time-series data. The PRC can accurately separate underlying features through mapping the input over time into a high-dimensional space from having non-linear dynamic qualities. The estimation system integrates the PRC while ensuring reliability and safety through predicting a PRC state and a reservoir drift using the system properties for the task. The PRC state can be changes in physical dynamics caused by unexpected events within the vehicle environment. Meanwhile, the reservoir drift can be associated with the PRC effected by experiencing the unexpected events that cause property degradation and deviations when predicting a parameter. As such, the estimation system can mitigate PRC degradation using the reservoir drift predicted by avoiding computational breakdown and parameter deviations over time. Accordingly, the estimation system improves accuracy for PRC operation within a vehicle environment by measuring the system properties reliably through monitoring and predicting the PRC state and the reservoir drift using system properties.

In one embodiment, an estimation system for monitoring the deviation of system properties for a PRC from environmental factors and mitigating the deviation is disclosed. The estimation system includes a memory storing instructions that, when executed by a processor, cause the processor to monitor system properties of a PRC that predicts a parameter for a vehicle environment during a task, and the PRC is associated with a ML model that outputs the parameter. The instructions also include instructions to predict a PRC state and a reservoir drift using the system properties. The instructions also include instructions to mitigate PRC degradation associated with the reservoir drift by a switch from the PRC to a computation framework, and the computation framework calculates the parameter using the ML model.

In one embodiment, a non-transitory computer-readable medium for monitoring deviation of system properties for a PRC from environmental factors and mitigating the deviation and including instructions that when executed by a processor cause the processor to perform one or more functions is disclosed. The instructions include instructions to monitor system properties of a PRC that predicts a parameter for a vehicle environment during a task, and the PRC is associated with a ML model that outputs the parameter. The instructions also include instructions to predict a PRC state and a reservoir drift using the system properties. The instructions also include instructions to mitigate PRC degradation associated with the reservoir drift by a switch from the PRC to a computation framework, and the computation framework calculates the parameter using the ML model.

In one embodiment, a method for monitoring the deviation of system properties for a PRC from environmental factors and mitigating the deviation is disclosed. In one embodiment, the method includes monitoring system properties of a PRC that predicts a parameter for a vehicle environment during a task, and the PRC is associated with a ML model that outputs the parameter. The method also includes predicting a PRC state and a reservoir drift using the system properties. The method also includes mitigating PRC degradation associated with the reservoir drift by switching from the PRC to a computation framework, and the computation framework calculates the parameter using the ML model.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates one embodiment of a vehicle within which systems and methods disclosed herein may be implemented.

FIG. 2 illustrates one embodiment of an estimation system that is associated with monitoring the deviation of system properties for a physical reservoir computer (PRC) from environmental factors and mitigating the deviation.

FIG. 3 illustrates one example of a PRC operating within a vehicle environment.

FIGS. 4A and 4B illustrate embodiments of the estimation system of FIG. 2 operating offline and online for preventing system degradation.

FIG. 5 illustrates one embodiment of a method that is associated with predicting a PRC state and a reservoir drift using system properties for mitigating system degradation.

### DETAILED DESCRIPTION

Systems, methods, and other embodiments associated with monitoring deviation of system properties for a physical reservoir computer (PRC) from environmental factors and mitigating the deviation using supervision are disclosed herein. Various architectures for a PRC include a light-based PRC, biochemical-based PRC, an electronic-based PRC, a mechanical-based PRC, a quantum-based PRC, acoustic PRC, etc. In various implementations, systems rely upon a PRC for performance-centric and critical computations involving estimations and prediction tasks associated with a time-series input. Here, a variable evolving over a time horizon that is extended can be a time-series. A PRC application can include acoustic modeling, sharing of a dynamic spectrum, multi-input multi-output (mimo) symbol detection, predictions involving a chaotic system, etc., that are dynamic. PRC reliability can depend upon monitoring system properties accurately through comparing an output with a known function. This raises design challenges as the known function can be unavailable and difficult to acquire.

Moreover, dynamical systems can demand maintaining certain system properties for reliable and safe operation. System properties can include a separability condition where different external inputs should excite a dynamical system into different regions of a state space. The dynamical system can describe how a system evolves over time from a current state and rules governing system dynamics. A forecast horizon (FH) captures a time period the PRC is able to accurately predict a parameter upon training. Furthermore, an echo state property (ESP) involves a property where inputs to a dynamical system should echo and potentially dissipate within the state space. Here, the dynamical system having greater sensitivity to initial conditions exhibits increased non-linearity. In one approach, dynamic changes in a vehicle environment induce substantial changes in moisture, temperature, pressure, mechanical stress, vibrations, heat, etc., that degrade the system properties and PRC performance when computing tasks. Thus, systems lacking capabilities to maintain system properties for a PRC can exhibit unreliable and unsafe conditions.

Therefore, in one embodiment, an estimation system robustly integrates a PRC by intelligently monitoring system properties and adjusting reliance through supervision (e.g., automatic supervision, manual supervision, etc.) to mitigate deviations resulting from environmental conditions. In one approach, the estimation system manages the PRC that computes operations for a machine learning (ML) model online within a vehicle environment. Here, the ML model can predict a paramater during a task (e.g., path planning). The estimation system predicts a PRC state and a reservoir drift using the system properties over time as the environmental conditions change. The reservoir drift can be a phenomenon of the PRC losing system properties. The PRC state can indicate the physical properties about a reservoir while the reservoir drift can represent the system properties (e.g., FH, ESP, etc.) deviating from an operating range. In this way, the estimation system can identify the impact on the PRC from the environmental conditions through insight gained from the PRC state and the reservoir drift.

In various implementations, monitoring the system properties involves the estimation system training offline for identifying nominal operation of the PRC. For instance, the training involves using a comparison between an input and a read-out from the PRC. Here, the comparison can help identify nominal values of the system properties and characteristics of the reservoir drift from changes among the system properties over time. Furthermore, the estimation system mitigates PRC degradation associated with changes in the PRC state and reservoir drift by switching from the PRC to another computation framework when operating online. For example, the estimation system switches from a PRC running a neural network to a graphics processing unit (GPU) for object detection when the reservoir drift indicates decreased computational accuracy from physical breakdown. Accordingly, the estimation system improves PRC reliability by monitoring system properties, predicting breakdown, and triggering a mitigation action, thereby sustaining PRC safety.

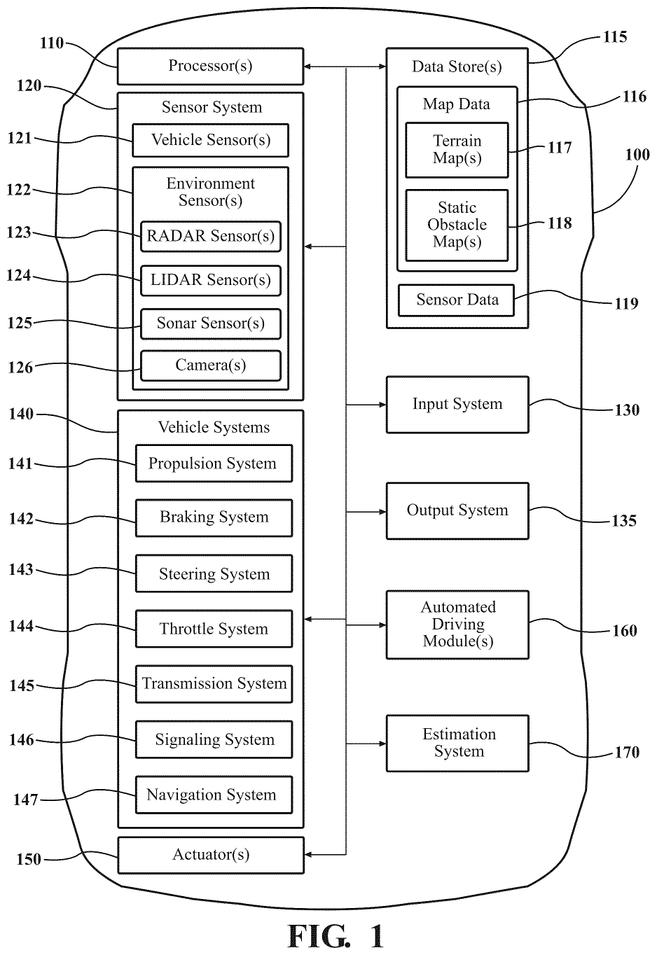

Referring to FIG. 1, an example of a vehicle 100 is illustrated. As used herein, a “vehicle” is any form of motorized transport. In one or more implementations, the vehicle 100 is an automobile. While arrangements will be described herein with respect to automobiles, it will be understood that embodiments are not limited to automobiles. In some implementations, an estimation system 170 uses road-side units (RSU), consumer electronics (CE), mobile devices, robots, drones, and so on that benefit from the functionality discussed herein associated with monitoring deviation of system properties for a PRC from environmental factors and mitigating the deviation using supervision (e.g., automatic supervision, manual supervision, etc.).

The vehicle 100 also includes various elements. It will be understood that in various embodiments, the vehicle 100 may have less than the elements shown in FIG. 1. The vehicle 100 can have any combination of the various elements shown in FIG. 1. Furthermore, the vehicle 100 can have additional elements to those shown in FIG. 1. In some arrangements, the vehicle 100 may be implemented without one or more of the elements shown in FIG. 1. While the various elements are shown as being located within the vehicle 100 in FIG. 1, it will be understood that one or more of these elements can be located external to the vehicle 100. Furthermore, the elements shown may be physically separated by large distances. For example, as discussed, one or more components of the disclosed system can be implemented within a vehicle while further components of the system are implemented within a cloud-computing environment or other system that is remote from the vehicle 100.

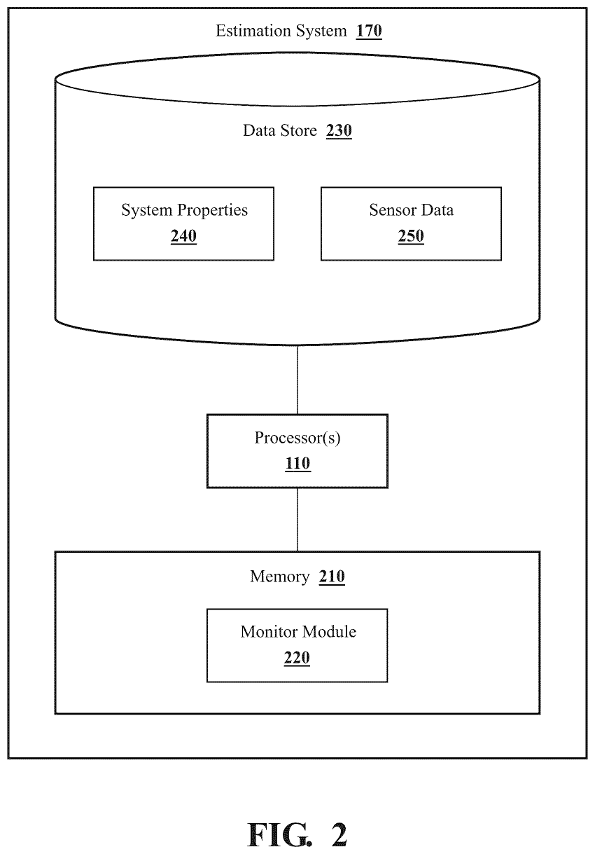

Some of the possible elements of the vehicle 100 are shown in FIG. 1 and will be described along with subsequent figures. However, a description of many of the elements in FIG. 1 will be provided after the discussion of FIGS. 2-5 for purposes of brevity of this description. Additionally, it will be appreciated that for simplicity and clarity of illustration, where appropriate, reference numerals have been repeated among the different figures to indicate corresponding or analogous elements. In addition, the discussion outlines numerous specific details to provide a thorough understanding of the embodiments described herein. Those of skill in the art, however, will understand that the embodiments described herein may be practiced using various combinations of these elements. In either case, the vehicle 100 includes an estimation system 170 that is implemented to perform methods and other functions as disclosed herein relating to monitoring deviation of system properties for a PRC from environmental factors and mitigating the deviation using supervision (e.g., automatic supervision, manual supervision, etc.).

With reference to FIG. 2, one embodiment of the estimation system 170 of FIG. 1 is further illustrated. The estimation system 170 is shown as including a processor(s) 110 from the vehicle 100 of FIG. 1. Accordingly, the processor(s) 110 may be a part of the estimation system 170, the estimation system 170 may include a separate processor from the processor(s) 110 of the vehicle 100, or the estimation system 170 may access the processor(s) 110 through a data bus or another communication path. In one embodiment, the estimation system 170 includes a memory 210 that stores a monitor module 220. The memory 210 is a random-access memory (RAM), a read-only memory (ROM), a hard-disk drive, a flash memory, or other suitable memory for storing the monitor module 220. The monitor module 220 is, for example, computer-readable instructions that when executed by the processor(s) 110 cause the processor(s) 110 to perform the various functions disclosed herein.

The estimation system 170 as illustrated in FIG. 2 is generally an abstracted form. Furthermore, the estimation system 170 and/or the monitor module 220 generally includes instructions that function to control the processor(s) 110 to receive data inputs from one or more sensors of the vehicle 100. The inputs are, in one embodiment, observations of one or more objects in an environment proximate to the vehicle 100 and/or other aspects about the surroundings. As provided for herein, the monitor module 220, in one embodiment, acquires sensor data 250 that includes at least camera images. In further arrangements, the monitor module 220 acquires the sensor data 250 from further sensors such as radar sensors 123, LIDAR sensors 124, and other sensors as may be suitable for identifying vehicles and locations of the vehicles.

Moreover, in one embodiment, the estimation system 170 includes a data store 230. In one embodiment, the data store 230 is a database. The database is, in one embodiment, an electronic data structure stored in the memory 210 or another data store and that is configured with routines that can be executed by the processor(s) 110 for analyzing stored data, providing stored data, organizing stored data, and so on. Thus, in one embodiment, the data store 230 stores data used by the monitor module 220 in executing various functions. In one embodiment, the data store 230 includes the sensor data 250 along with, for example, metadata that characterize various aspects of the sensor data 250.

In another embodiment, the data store 230 further includes system properties 240 that is one a FH, a Lyapunov coefficient, feature separability, an echo state, non-linearity, and memory. In one approach, the system properties 240 have a vector form that reduces computational costs from parsing. A FH can capture a time period where a PRC can accurately predict parameters that the PRC is trained to estimate. The Lyapunov coefficient can indicate an amount that PRC states contract and expand, thereby reflecting system chaos and stability. The feature separability can be associated with excitations of a dynamical system from different external inputs into different regions of a state space. The dynamical system can describe how a system evolves over time from a current state and rules governing system dynamics. Furthermore, the echo state is a property where inputs to the dynamical system should echo within the state space and sometimes dissipate. For instance, the echo state is quantified with the spectral radius represented as ρ(W) that is the largest absolute value eigenvalues and the echo state can be ρ(W)<1.

Moreover, the non-linearity and memory properties can be associated with the sensitivity of the PRC with initial conditions. The dynamical system exhibits increased non-linearity when having greater sensitivity to initial conditions. In this way, computations can explore the underlying state-space for small variations to inputs.

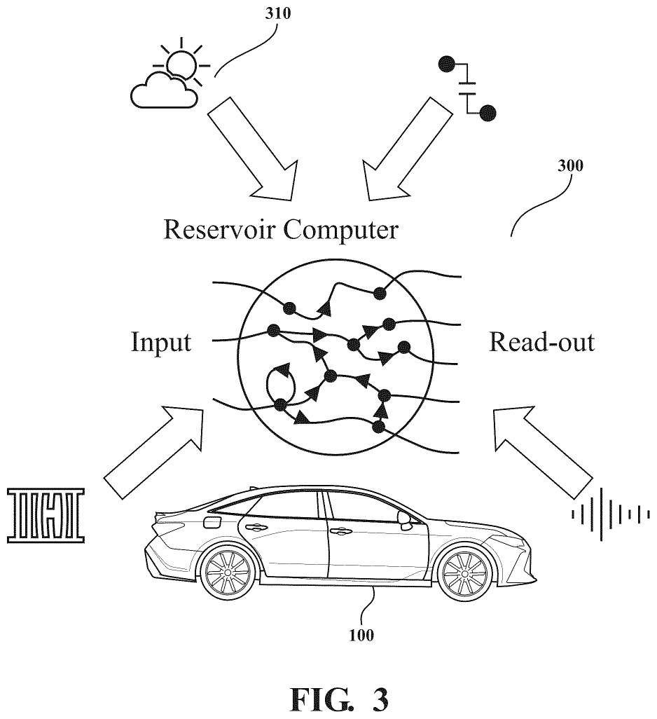

Now turning to FIG. 3, one example of a PRC operating within a vehicle environment is illustrated. In FIG. 3, the example given can similarly apply to a PRC operating in other environments (e.g., an industrial environment) where physical phenomena affect computational performance. Here, PRC 300 involves acquiring a read-out from a corresponding input when executing instructions for a computation model. For instance, the computation model predicts a parameter for an automated dynamic object (ADO) vehicle that the vehicle 100 is following using a function, a learning model, a neural network (NN), etc. Furthermore, the PRC 300 has internal dynamics that is a physical embodiment (e.g., analog circuitry) of the computation model and the physical embodiment saves power and manufacturing costs over platforms using traditional computing (e.g., a graphics processing unit (GPU), application-specific integrated circuit (ASIC), etc.). Gains from a reservoir computer can be attributed to the universal approximation theorem associated with dynamical and chaotic systems when forecasting parameters that improve inference and training speeds. The universal approximation theorem states that such systems have accessible state spaces for a function to output predictions when trained with a reference signal and the function adjusts parameters through the training, such as by reducing prediction losses.

In various implementations, the PRC 300 implements a ML model that predicts a parameter for completing a task associated with the vehicle 100. Here, the PRC 300 can encounter difficulties with safely predicting the parameter from environmental factors 310 associated with a vehicle environment. The environmental factors 310 can include physical phenomena involving dynamics that induce changes in moisture, temperature, pressure, mechanical stress, vibrations, heat, etc., to an operating environment associated with the vehicle 100. As such, the environmental factors 310 can decrease accuracy when predicting the parameter during an extended time horizon. For example, the PRC 300 forecasting a variable associated with a time-series that evolves over time is vulnerable to the environmental factors 310. In a vehicle environment, the time-series can involve parameter predictions for object motion, a battery state, motion dynamics, etc., associated with the vehicle 100. Therefore, the estimation system 170 estimates and monitors a physical state of the PRC 300 and mitigates detrimental effects to computations, thereby allowing a graceful transition between tasks.

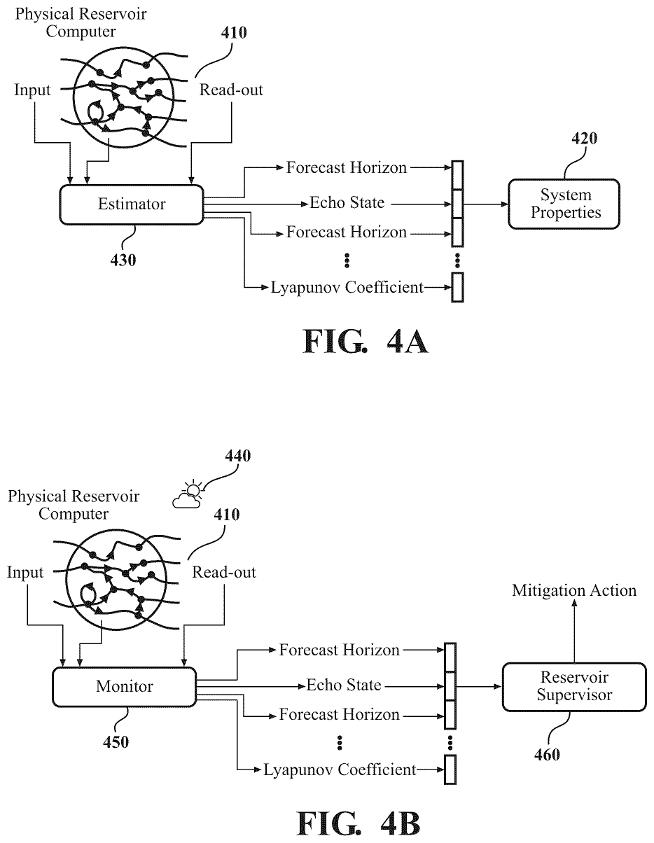

Regarding FIGS. 4A and 4B, embodiments of the estimation system 170 of FIG. 2 operating offline for estimating system properties as a design phase and operating online for preventing system degradation through monitoring are illustrated. In FIG. 4A, the estimation system 170 includes instructions that cause the processor 110 to estimate the system properties 420 for a PRC 410 during nominal operation using the estimator 430 and utilize the design during online monitoring. Here, the system properties 420 may be similar to the system properties 240 that includes an echo state a memory, a Lyapunov coefficient, etc. For example, the estimator 430 compares an input and a read-out from the PRC 410 for nominal values of the system properties 420 such as FH, echo state, and a Lyapunov coefficient changing during a time-series for a task. A vehicle application (e.g., path planning) can be executing the task using a computation model, such as a ML model that is pre-trained.

Moreover, the estimation system 170 when deployed in the vehicle 100 can identify a reservoir drift from changes and deviations among the system properties 420 from a range (e.g., a safety range, a temperature range, etc.) involving a dynamical system from observations made offline. As previously explained, reservoir drift can be the PRC 410 losing the system properties 420 such that computations and performance become unreliable. For instance, the system properties 420 for a micro-fluidic based PRC rapidly and uncharacteristically change with leak in a fluidic array. In quantum mechanics, the system properties 420 of the PRC 410 can change when coherence for a quantum state collapses from environmental perturbations that are unforeseen. In this way, the estimation system 170 can observe the PRC 410 for reservoir drift where the PRC is unreliable during various scenarios.

In one embodiment, the estimator 430 observes causes of the reservoir drift offline to mitigate computational difficulties online during implementation in the vehicle 100. Furthermore, the fidelity and accuracy of the PRC 410 and the system properties 420 during the reservoir drift can depend upon applications. For instance, the system properties 420 should be estimated with elevated fidelity and across complete operating domains for applications involving automated driving. As such, the estimation system 170 can detect computational abnormalities for the PRC 410 by estimating the system properties 420 during nominal operation.

Turning to FIG. 4B, the input can be information that excites the PRC 410 for identifying and predicting the reservoir drift when observing changes among the system properties 420 upon implementation in the vehicle 100. For example, the excitation input is an image used to train a learning model (e.g., a NN (DNN)) and output classes that the monitor 450 detects for the reservoir drift. In one embodiment, the monitor module 220 and/or estimation system 170 include instructions that cause the processor 110 to monitor the system properties 240 of the PRC 410 that predicts a parameter for a vehicle environment during a task. Here, the PRC 410 can have a structure similar to the PRC 300 and physically embody a computation model such as with analog circuitry. In one approach, the PRC 410 is associated with a ML model that outputs the parameter and the PRC 410 operates online while the vehicle 100 is active. The parameter can be associated with computations as a time-series. The task is associated with a dynamical system (e.g., a linear-dynamical system). Examples of a task include path planning, driving control, object detection, operating one or more of the vehicle systems 140, etc.

Moreover, the monitor module 220 and/or estimation system 170 can predict a PRC state and a reservoir drift through observations involving the system properties 240 affected by the environmental factors 440. As previously explained, the PRC state can indicate the physical properties about a reservoir while the reservoir drift can represent the system properties (e.g., FH, ESP, etc.) deviating from an operating range. In more detail, the PRC state can be a high-dimensional representation internally corresponding with the dynamics of the PRC 410. For example, the PRC state is position, speed, acceleration, etc., of an oscillator(s) when the PRC 410 is associated with a harmonic oscillator. The reservoir drift for the harmonic oscillator can be the effects on the system properties 240 from thermal conditions of the harmonic oscillator changing that impacts damping of oscillator(s).

Similar to the environmental factors 310, the environmental factors 440 can include physical phenomena where dynamics induce changes in moisture, temperature, pressure, mechanical stress, vibrations, heat, etc., to an operating environment associated the vehicle 100. Here, the estimation system 170 can utilize monitor 450 for measuring changes to the system properties 240 and compare the changes with the system properties 420 for abnormalities. In one approach, the estimation system 170 mitigates PRC degradation associated with the reservoir drift by switching from the PRC 410 to another computation framework and the computation framework calculates the parameter.

In one embodiment, the reservoir supervisor 460 is switching logic that takes measurement estimations for the system properties 240 and identifies the reservoir drift. The reservoir supervisor 460 can trigger a mitigation action that includes transitioning the PRC 410 to one of a vehicle PRC, a different PRC operation within the vehicle 100, a reservoir model on a GPU, a model mimicking a reservoir computer on the GPU, a reservoir computer running on an ASIC, an ASIC, and a GPU. As such, the mitigation action switches from the PRC 410 to another computing framework that can execute a computational task with increased accuracy and stability. The mitigation action can also be an operator taking over control from an automated system while driving the vehicle 100. In this way, the mitigation action can avoid unsafe operation involving the PRC 410 associated with a driving task for the automated system.

In an implementation, the estimation system 170 computes one of a direct and indirect measurement of the system properties 240 for predicting the PRC state and the reservoir drift. For instance, the monitor 450 computes a direct measurement online using the PRC 410 while the vehicle 100 travels within the vehicle environment and experiences the environmental factors 440. As such, the reservoir drift can be derived from the direct measurement by the estimation system 170 and/or reservoir supervisor 460.

Moreover, an indirect measurement can involve comparing a computation from the PRC 410 with similar computations from other computation frameworks. For example, a redundant ensemble is an approach involving a computation framework that is a vehicle PRC having the same type as the PRC 410, a non-PRC (e.g., a reservoir model on a GPU, and the reservoir model running on an ASIC), etc., generating redundant outputs using a computation model (e.g., a NN, a DNN). Here, the computation framework and the computation model process inputs similar to that utilized by the PRC 410 and computes a parameter for a task online. In this way, the estimation system 170 and/or reservoir supervisor 460 can compare the parameter outputted from the PRC 410 with that from the computation framework for deriving the PRC state, the reservoir drift, computational deviation, etc., associated with the system properties 240 of the PRC 410 accordingly.

The approach for the redundant ensemble can vary for outputting redundant computations. For example, redundancy includes comparing outputs from two or more additional PRCs representing the same type as the PRC 410 and that process similar inputs as the PRC 410. In another embodiment, redundancy includes comparing outputs from two or more additional PRCs that are different than the PRC 410 and process a same input. For instance, the two or more additional PRCs are composed of physical substrates that are different. Furthermore, in one embodiment, the estimation system 170 compares a first forecast horizon (FH) of the PRC 410 using a known input (e.g., an input sequence, a test image, etc.) for the task with a second FH for the task using a computation framework that varies from the PRC 410. For example, the computation framework includes other PRCs in the redundant ensemble having physical substrates for the reservoir model that are different from the PRC 410.

Another indirect measurement for predicting the PRC state and reservoir drift for the PRC 410 can be a composition approach. Composition can involve using a computation framework that is a vehicle PRC, a non-PRC (e.g., a reservoir model on a GPU, and the reservoir model running on an ASIC), etc., executing instructions for a computation model (e.g., a pre-trained ML model, a NN, a DNN). For example, the estimation system 170 trains the computation framework using a comparison between an output signal from an output layer of the PRC 410 for nominal operation with a corresponding input signal from an input layer. Here, the input signal excites the system properties 240 for various driving environments. The estimation system 170 can compute the PRC state by combining and composing predictions from two or more of the computation frameworks and the computation models. In this way, the estimation system 170 can identify reservoir drift when the output signal deviates from an operating range associated with the predictions (e.g., a significant shift of a FH).

Regarding additional details for mitigating PRC degradation, the estimation system 170 and/or the monitor module 220 can identify a first subspace of the PRC 410 having reservoir drift and a second subspace lacking the reservoir drift. For instance, the second subspace lacks the reservoir drift due to internal dynamics being different from the first subspace and the internal dynamics are more stable for the environmental factors 440. As such, an output from the first subspace has an increased degradation weight compared with the second subspace since the reservoir drift is germane and confined to the first subspace. For example, an inference from computations using a ML model with the PRC 410 is valid for some tasks and invalid for others. As such, the reservoir supervisor 460 can trigger a mitigation action by switching to another computation framework for the first subspace, thereby avoiding the PRC degradation.

In various implementations, the estimation system 170 predicts a reservoir drift among the system properties 240 but deems the reservoir drift to be stable such the system properties 240 are still met. Here, the system properties 240 may be different than the system properties 420 identified for the PRC 410. The estimation system 170 mitigates PRC degradation by tuning variables of the PRC 410 using feedback from one of an operating range that is safe and the system properties 240 measured with the monitor 450. In this approach, read-out layers of the PRC 410 are re-trained to accommodate the change in the internal dynamics of the PRC 410.

Another form of monitoring the system properties 240 online involves a mixture-of-experts (MoE) approach. Here, PRCs are composed into a MoE (e.g., an ensemble). The individual results of the PRCs are weighted using degrees of reservoir drift involving the system properties 240 of the PRC 410. Accordingly, the estimation system 170 can accurately predict the abnormalities and instability of the PRC 410 using direct and indirect measurements and mitigate PRC degradation accordingly, thereby improving the reliability of the PRC 410 among a vehicle environment.

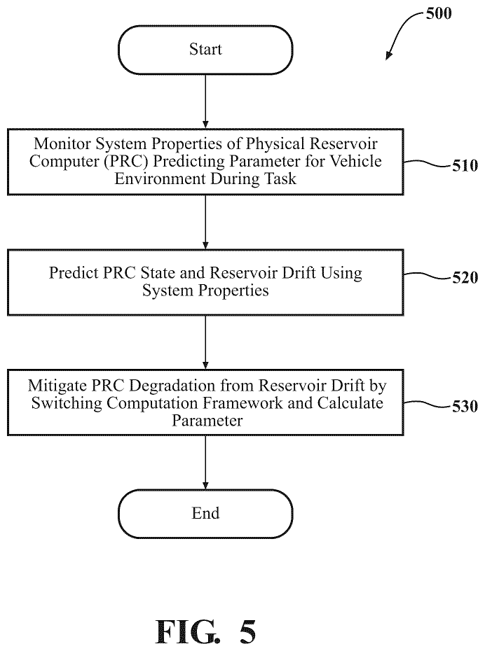

Turning to FIG. 5, one embodiment of a method 500 that is associated with predicting a PRC state and a reservoir drift using the system properties 240 for mitigating degradation is illustrated. FIG. 5 illustrates a flowchart of the method 500 that is associated with monitoring deviation of the system properties 240 for a PRC from environmental factors and mitigating the deviation using supervision (e.g., automatic supervision, manual supervision, etc.). Method 500 will be discussed from the perspective of the estimation system 170 of FIGS. 1 and 2. While the method 500 is discussed in combination with the estimation system 170, it should be appreciated that the method 500 is not limited to being implemented within the estimation system 170 but is instead one example of a system that may implement the method 500.

At 510, the estimation system 170 and/or the monitor module 220 monitor the system properties 240 of the PRC predicting a parameter for a vehicle environment during a task. Here, the parameter can be associated with computations as a time-series for forecasting a variable that evolves over time using a ML model and the variable is vulnerable to environmental factors associated with the vehicle 100. Furthermore, the task can be associated with path planning, driving control, object detection, operating one or more of the vehicle systems 140, etc., or any other dynamical system (e.g., a linear-dynamical system). In one approach, the PRC is associated with the ML model that outputs the parameter and the PRC operates online while the vehicle 100 is active. For instance, a parameter is a prediction for object motion, a battery state, motion dynamics, etc., having a time-series form.

At 520, the estimation system 170 predicts a PRC state and a reservoir drift using the system properties 240. Here, observations involving the system properties 240 affected by environmental factors can cause problematic changes in the PRC state and the reservoir drift. In one approach, the PRC state can indicate the physical properties about a reservoir while the reservoir drift can represent the system properties (e.g., FH, ESP, etc.) deviating from an operating range. As such, the PRC state can be high-dimensional representation internally corresponding with the dynamics of the PRC.

The environmental factors can include physical phenomena where dynamics induce changes in moisture, temperature, pressure, mechanical stress, vibrations, heat, etc., to an operating environment associated the vehicle 100. Furthermore, the estimation system 170 can utilize a monitor for measuring changes to the system properties 240 and compare the changes with system properties during nominal operation for abnormalities and instability.

Monitoring can involve one of a direct and an indirect measurement of the system properties 240 for predicting the PRC state and the reservoir drift. For instance, estimation system 170 computes a direct measurement online using the PRC while the vehicle 100 travels within the vehicle environment and experiences environmental factors. Moreover, as previously described, an indirect measurement can involve comparing a computation from the PRC with similar computations from other computation frameworks involving one of redundant and composition architectures. In this way, the estimation system 170 can trigger a mitigation action from abnormalities involving the PRC state and the reservoir drift.

At 530, the estimation system 170 mitigates PRC degradation associated with the reservoir drift by switching from the PRC to another computation framework. Here, the computation framework calculates the parameter rather than the PRC. For instance, the computation framework is one of a vehicle PRC, a reservoir model on a GPU, a model mimicking a reservoir computer on the GPU, a reservoir computer running on an ASIC, an ASIC, and a GPU executing instructions for one of a pre-trained ML model, a NN, a DNN, etc. In one approach, the mitigation action involve an operator taking over control from an automated system while driving the vehicle 100, thereby avoiding unsafe operation involving the PRC when processing a driving task for the automated system. Accordingly, the estimation system 170 identifies operational difficulties for the PRC from environmental conditions associated with a vehicle environment and intelligently mitigates degradation for improving computational reliability, such as through switching to another computation framework.

FIG. 1 will now be discussed in full detail as an example environment within which the system and methods disclosed herein may operate. In some instances, the vehicle 100 is configured to switch selectively between different modes of operation/control according to the direction of one or more modules/systems of the vehicle 100. In one approach, the modes include: 0, no automation; 1, driver assistance; 2, partial automation; 3, conditional automation; 4, high automation; and 5, full automation. In one or more arrangements, the vehicle 100 can be configured to operate in a subset of possible modes.

In one or more embodiments, the vehicle 100 is an automated or autonomous vehicle. As used herein, “autonomous vehicle” refers to a vehicle that is capable of operating in an autonomous mode (e.g., category 5, full automation). “Automated mode” or “autonomous mode” refers to navigating and/or maneuvering the vehicle 100 along a travel route using one or more computing systems to control the vehicle 100 with minimal or no input from a human driver. In one or more embodiments, the vehicle 100 is highly automated or completely automated. In one embodiment, the vehicle 100 is configured with one or more semi-autonomous operational modes in which one or more computing systems perform a portion of the navigation and/or maneuvering of the vehicle along a travel route, and a vehicle operator (i.e., driver) provides inputs to the vehicle to perform a portion of the navigation and/or maneuvering of the vehicle 100 along a travel route.

The vehicle 100 can include one or more processors 110. In one or more arrangements, the processor(s) 110 can be a main processor of the vehicle 100. For instance, the processor(s) 110 can be an electronic control unit (ECU), an application-specific integrated circuit (ASIC), a microprocessor, etc. The vehicle 100 can include one or more data stores 115 for storing one or more types of data. The data store(s) 115 can include volatile and/or non-volatile memory. Examples of suitable data stores 115 include RAM, flash memory, ROM, programmable read-only memory (PROM), erasable programmable read-only memory (EPROM), electrically erasable programmable read-only memory (EEPROM), registers, magnetic disks, optical disks, and hard drives. The data store(s) 115 can be a component of the processor(s) 110, or the data store(s) 115 can be operatively connected to the processor(s) 110 for use thereby. The term “operatively connected,” as used throughout this description, can include direct or indirect connections, including connections without direct physical contact.

In one or more arrangements, the one or more data stores 115 can include map data 116. The map data 116 can include maps of one or more geographic areas. In some instances, the map data 116 can include information or data on roads, traffic control devices, road markings, structures, features, and/or landmarks in the one or more geographic areas. The map data 116 can be in any suitable form. In some instances, the map data 116 can include aerial views of an area. In some instances, the map data 116 can include ground views of an area, including 360-degree ground views. The map data 116 can include measurements, dimensions, distances, and/or information for one or more items included in the map data 116 and/or relative to other items included in the map data 116. The map data 116 can include a digital map with information about road geometry.

In one or more arrangements, the map data 116 can include one or more terrain maps 117. The terrain map(s) 117 can include information about the terrain, roads, surfaces, and/or other features of one or more geographic areas. The terrain map(s) 117 can include elevation data in the one or more geographic areas. The terrain map(s) 117 can define one or more ground surfaces, which can include paved roads, unpaved roads, land, and other things that define a ground surface.

In one or more arrangements, the map data 116 can include one or more static obstacle maps 118. The static obstacle map(s) 118 can include information about one or more static obstacles located within one or more geographic areas. A “static obstacle” is a physical object whose position does not change or substantially change over a period of time and/or whose size does not change or substantially change over a period of time. Examples of static obstacles can include trees, buildings, curbs, fences, railings, medians, utility poles, statues, monuments, signs, benches, furniture, mailboxes, large rocks, or hills. The static obstacles can be objects that extend above ground level. The one or more static obstacles included in the static obstacle map(s) 118 can have location data, size data, dimension data, material data, and/or other data associated with it. The static obstacle map(s) 118 can include measurements, dimensions, distances, and/or information for one or more static obstacles. The static obstacle map(s) 118 can be high quality and/or highly detailed. The static obstacle map(s) 118 can be updated to reflect changes within a mapped area.

One or more data stores 115 can include sensor data 119. In this context, “sensor data” means any information about the sensors that the vehicle 100 is equipped with, including the capabilities and other information about such sensors. As will be explained below, the vehicle 100 can include the sensor system 120. The sensor data 119 can relate to one or more sensors of the sensor system 120. As an example, in one or more arrangements, the sensor data 119 can include information about one or more LIDAR sensors 124 of the sensor system 120.

In some instances, at least a portion of the map data 116 and/or the sensor data 119 can be located in one or more data stores 115 located onboard the vehicle 100. Alternatively, or in addition, at least a portion of the map data 116 and/or the sensor data 119 can be located in one or more data stores 115 that are located remotely from the vehicle 100.

As noted above, the vehicle 100 can include the sensor system 120. The sensor system 120 can include one or more sensors. “Sensor” means a device that can detect, and/or sense something. In at least one embodiment, the one or more sensors detect, and/or sense in real-time. As used herein, the term “real-time” means a level of processing responsiveness that a user or system senses as sufficiently immediate for a particular process or determination to be made, or that enables the processor to keep up with some external process.

In arrangements in which the sensor system 120 includes a plurality of sensors, the sensors may function independently or two or more of the sensors may function in combination. The sensor system 120 and/or the one or more sensors can be operatively connected to the processor(s) 110, the data store(s) 115, and/or another element of the vehicle 100. The sensor system 120 can produce observations about a portion of the environment of the vehicle 100 (e.g., nearby vehicles).

The sensor system 120 can include any suitable type of sensor. Various examples of different types of sensors will be described herein. However, it will be understood that the embodiments are not limited to the particular sensors described. The sensor system 120 can include one or more vehicle sensors 121. The vehicle sensor(s) 121 can detect information about the vehicle 100 itself. In one or more arrangements, the vehicle sensor(s) 121 can be configured to detect position and orientation changes of the vehicle 100, such as, for example, based on inertial acceleration. In one or more arrangements, the vehicle sensor(s) 121 can include one or more accelerometers, one or more gyroscopes, an inertial measurement unit (IMU), a dead-reckoning system, a global navigation satellite system (GNSS), a global positioning system (GPS), a navigation system 147, and/or other suitable sensors. The vehicle sensor(s) 121 can be configured to detect one or more characteristics of the vehicle 100 and/or a manner in which the vehicle 100 is operating. In one or more arrangements, the vehicle sensor(s) 121 can include a speedometer to determine a current speed of the vehicle 100.

Alternatively, or in addition, the sensor system 120 can include one or more environment sensors 122 configured to acquire data about an environment surrounding the vehicle 100 in which the vehicle 100 is operating. “Surrounding environment data” includes data about the external environment in which the vehicle is located or one or more portions thereof. For example, the one or more environment sensors 122 can be configured to sense obstacles in at least a portion of the external environment of the vehicle 100 and/or data about such obstacles. Such obstacles may be stationary objects and/or dynamic objects. The one or more environment sensors 122 can be configured to detect other things in the external environment of the vehicle 100, such as, for example, lane markers, signs, traffic lights, traffic signs, lane lines, crosswalks, curbs proximate to the vehicle 100, off-road objects, etc.

Various examples of sensors of the sensor system 120 will be described herein. The example sensors may be part of the one or more environment sensors 122 and/or the one or more vehicle sensors 121. However, it will be understood that the embodiments are not limited to the particular sensors described.

As an example, in one or more arrangements, the sensor system 120 can include one or more of: radar sensors 123, LIDAR sensors 124, sonar sensors 125, weather sensors, haptic sensors, locational sensors, and/or one or more cameras 126. In one or more arrangements, the one or more cameras 126 can be high dynamic range (HDR) cameras, stereo, or infrared (IR) cameras.

The vehicle 100 can include an input system 130. An “input system” includes components or arrangement or groups thereof that enable various entities to enter data into a machine. The input system 130 can receive an input from a vehicle occupant. The vehicle 100 can include an output system 135. An “output system” includes one or more components that facilitate presenting data to a vehicle occupant.

The vehicle 100 can include one or more vehicle systems 140. Various examples of the one or more vehicle systems 140 are shown in FIG. 1. However, the vehicle 100 can include more, fewer, or different vehicle systems. It should be appreciated that although particular vehicle systems are separately defined, any of the systems or portions thereof may be otherwise combined or segregated via hardware and/or software within the vehicle 100. The vehicle 100 can include a propulsion system 141, a braking system 142, a steering system 143, a throttle system 144, a transmission system 145, a signaling system 146, and/or a navigation system 147. Any of these systems can include one or more devices, components, and/or a combination thereof, now known or later developed.

The navigation system 147 can include one or more devices, applications, and/or combinations thereof, now known or later developed, configured to determine the geographic location of the vehicle 100 and/or to determine a travel route for the vehicle 100. The navigation system 147 can include one or more mapping applications to determine a travel route for the vehicle 100. The navigation system 147 can include a global positioning system, a local positioning system, or a geolocation system.

The processor(s) 110, the estimation system 170, and/or the automated driving module(s) 160 can be operatively connected to communicate with the various vehicle systems 140 and/or individual components thereof. For example, the processor(s) 110 and/or the automated driving module(s) 160 can be in communication to send and/or receive information from the various vehicle systems 140 to control the movement of the vehicle 100. The processor(s) 110, the estimation system 170, and/or the automated driving module(s) 160 may control some or all of the vehicle systems 140 and, thus, may be partially or fully autonomous as defined by the society of automotive engineers (SAE) levels 0 to 5.

The processor(s) 110, the estimation system 170, and/or the automated driving module(s) 160 can be operatively connected to communicate with the various vehicle systems 140 and/or individual components thereof. For example, the processor(s) 110, the estimation system 170, and/or the automated driving module(s) 160 can be in communication to send and/or receive information from the various vehicle systems 140 to control the movement of the vehicle 100. The processor(s) 110, the estimation system 170, and/or the automated driving module(s) 160 may control some or all of the vehicle systems 140.

The processor(s) 110, the estimation system 170, and/or the automated driving module(s) 160 may be operable to control the navigation and maneuvering of the vehicle 100 by controlling one or more of the vehicle systems 140 and/or components thereof. For instance, when operating in an autonomous mode, the processor(s) 110, the estimation system 170, and/or the automated driving module(s) 160 can control the direction and/or speed of the vehicle 100. The processor(s) 110, the estimation system 170, and/or the automated driving module(s) 160 can cause the vehicle 100 to accelerate, decelerate, and/or change direction. As used herein, “cause” or “causing” means to make, force, compel, direct, command, instruct, and/or enable an event or action to occur or at least be in a state where such event or action may occur, either in a direct or indirect manner.

The vehicle 100 can include one or more actuators 150. The actuators 150 can be an element or a combination of elements operable to alter one or more of the vehicle systems 140 or components thereof responsive to receiving signals or other inputs from the processor(s) 110 and/or the automated driving module(s) 160. For instance, the one or more actuators 150 can include motors, pneumatic actuators, hydraulic pistons, relays, solenoids, and/or piezoelectric actuators, just to name a few possibilities.

The vehicle 100 can include one or more modules, at least some of which are described herein. The modules can be implemented as computer-readable program code that, when executed by a processor(s) 110, implement one or more of the various processes described herein. One or more of the modules can be a component of the processor(s) 110, or one or more of the modules can be executed on and/or distributed among other processing systems to which the processor(s) 110 is operatively connected. The modules can include instructions (e.g., program logic) executable by one or more processors 110. Alternatively, or in addition, one or more data stores 115 may contain such instructions.

In one or more arrangements, one or more of the modules described herein can include artificial intelligence elements, e.g., neural network, fuzzy logic, or other machine learning algorithms. Furthermore, in one or more arrangements, one or more of the modules can be distributed among a plurality of the modules described herein. In one or more arrangements, two or more of the modules described herein can be combined into a single module.

The vehicle 100 can include one or more automated driving modules 160. The automated driving module(s) 160 can be configured to receive data from the sensor system 120 and/or any other type of system capable of capturing information relating to the vehicle 100 and/or the external environment of the vehicle 100. In one or more arrangements, the automated driving module(s) 160 can use such data to generate one or more driving scene models. The automated driving module(s) 160 can determine position and velocity of the vehicle 100. The automated driving module(s) 160 can determine the location of obstacles, obstacles, or other environmental features including traffic signs, trees, shrubs, neighboring vehicles, pedestrians, etc.

The automated driving module(s) 160 can be configured to receive, and/or determine location information for obstacles within the external environment of the vehicle 100 for use by the processor(s) 110, and/or one or more of the modules described herein to estimate position and orientation of the vehicle 100, vehicle position in global coordinates based on signals from a plurality of satellites, or any other data and/or signals that could be used to determine the current state of the vehicle 100 or determine the position of the vehicle 100 with respect to its environment for use in either creating a map or determining the position of the vehicle 100 in respect to map data.

The automated driving module(s) 160 either independently or in combination with the estimation system 170 can be configured to determine travel path(s), current autonomous driving maneuvers for the vehicle 100, future autonomous driving maneuvers and/or modifications to current autonomous driving maneuvers based on data acquired by the sensor system 120, driving scene models, and/or data from any other suitable source such as determinations from the sensor data 250. “Driving maneuver” means one or more actions that affect the movement of a vehicle. Examples of driving maneuvers include: accelerating, decelerating, braking, turning, moving in a lateral direction of the vehicle 100, changing travel lanes, merging into a travel lane, and/or reversing, just to name a few possibilities. The automated driving module(s) 160 can be configured to implement determined driving maneuvers. The automated driving module(s) 160 can cause, directly or indirectly, such autonomous driving maneuvers to be implemented. As used herein, “cause” or “causing” means to make, command, instruct, and/or enable an event or action to occur or at least be in a state where such event or action may occur, either in a direct or indirect manner. The automated driving module(s) 160 can be configured to execute various vehicle functions and/or to transmit data to, receive data from, interact with, and/or control the vehicle 100 or one or more systems thereof (e.g., one or more of vehicle systems 140).

Detailed embodiments are disclosed herein. However, it is to be understood that the disclosed embodiments are intended as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Furthermore, the terms and phrases used herein are not intended to be limiting but rather to provide an understandable description of possible implementations. Various embodiments are shown in FIGS. 1-5, but the embodiments are not limited to the illustrated structure or application.

The flowcharts and block diagrams in the figures illustrate the architecture, functionality, and operation of possible implementations of systems, methods, and computer program products according to various embodiments. In this regard, a block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components, and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suited. A typical combination of hardware and software can be a processing system with computer-usable program code that, when being loaded and executed, controls the processing system such that it carries out the methods described herein.

The systems, components, and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: a portable computer diskette, a hard disk drive (HDD), a solid-state drive (SSD), a ROM, an EPROM or flash memory, a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

Generally, modules as used herein include routines, programs, objects, components, data structures, and so on that perform particular tasks or implement particular data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an ASIC, a hardware component of a system on a chip (SoC), as a programmable logic array (PLA), or as another suitable hardware component that is embedded with a defined configuration set (e.g., instructions) for performing the disclosed functions.

Program code embodied on a computer-readable medium may be transmitted using any appropriate medium, including but not limited to wireless, wireline, optical fiber, cable, radio frequency (RF), etc., or any suitable combination of the foregoing. Computer program code for carrying out operations for aspects of the present arrangements may be written in any combination of one or more programming languages, including an object-oriented programming language such as Java™, Smalltalk™, C++, or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . ” as used herein refers to and encompasses any and all combinations of one or more of the associated listed items. As an example, the phrase “at least one of A, B, and C” includes A, B, C, or any combination thereof (e.g., AB, AC, BC, or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. An estimation system comprising:
a memory storing instructions that, when executed by a processor, cause the processor to:
monitor system properties of a physical reservoir computer (PRC) that predicts a parameter for a vehicle environment during a task, and the PRC is associated with a machine learning (ML) model that outputs the parameter;
predict a PRC state and a reservoir drift using the system properties; and
mitigate PRC degradation associated with the reservoir drift by a switch from the PRC to a computation framework, and the computation framework calculates the parameter using the ML model.

2. The estimation system of claim 1 further including instructions to:
estimate the system properties offline for nominal operation using a comparison between an input and a read-out from the PRC, the nominal operation associated with a vehicle application; and
identify characteristics of the reservoir drift from changes among the system properties.

3. The estimation system of claim 1, wherein the instructions to predict the PRC state further include instructions to:
compute a direct measurement of the system properties online while a vehicle travels within the vehicle environment; and
calculate the reservoir drift using the direct measurement.

4. The estimation system of claim 1, wherein the instructions to predict the PRC state further include instructions to:
compute the parameter for the task online using the computation framework, and the computation framework is one of a vehicle PRC, a reservoir model on a graphics processing unit (GPU), and the reservoir model running on an application-specific integrated circuit (ASIC); and
compare the parameter outputted from the PRC with that from the computation framework.

5. The estimation system of claim 4 further including instructions to:
compare a first forecast horizon (FH) of the PRC using a known input for the task with a second FH for the task using the computation framework; and
the computation framework includes physical substrates for the reservoir model that are different from the PRC.

6. The estimation system of claim 1, wherein the instructions to mitigate the PRC degradation further include instructions to:
identify a first subspace of the PRC having the reservoir drift and a second subspace lacking the reservoir drift, wherein an output from the first subspace has a degradation weight that is increased from the second subspace; and
switch to the computation framework for the first subspace.

7. The estimation system of claim 1 further including instructions to
train the computation framework using a comparison between an output signal from an output layer of the PRC with a corresponding input signal from an input layer, wherein the input signal excites the system properties for the vehicle environment;
compute the PRC state by combining predictions from the computation framework that is one of a vehicle PRC, a reservoir model on a GPU, and a reservoir computer running on an ASIC; and
identify characteristics of the reservoir drift when the output signal deviates from an operating range associated with the predictions.

8. The estimation system of claim 7, wherein instructions to mitigate the PRC degradation further include:
tune variables of the PRC using feedback from one of the operating range and the system properties.

9. The estimation system of claim 1, wherein:
the reservoir drift is one of a coherence of a quantum state collapsing from an environmental perturbation, a leak occurring in a fluidic array, and the system properties deviating from an operating range;
the system properties are one of a forecast horizon, an echo state, a Lyapunov coefficient, feature separability, non-linearity, and memory;
the computation framework is one of a vehicle PRC, a reservoir model on a GPU, a reservoir computer running on an ASIC, an ASIC, and the GPU; and
the parameter is associated with computations as a time-series and the task is associated with a linear-dynamical system.

10. A non-transitory computer-readable medium comprising:
instructions that when executed by a processor cause the processor to:
monitor system properties of a physical reservoir computer (PRC) that predicts a parameter for a vehicle environment during a task, and the PRC is associated with a machine learning (ML) model that outputs the parameter;
predict a PRC state and a reservoir drift using the system properties; and
mitigate PRC degradation associated with the reservoir drift by a switch from the PRC to a computation framework, and the computation framework calculates the parameter using the ML model.

11. The non-transitory computer-readable medium of claim 10, wherein the instructions to predict the PRC state further include instructions to:
compute a direct measurement of the system properties online while a vehicle travels within the vehicle environment; and
calculate the reservoir drift using the direct measurement.

12. A method comprising:
monitoring system properties of a physical reservoir computer (PRC) that predicts a parameter for a vehicle environment during a task, and the PRC is associated with a machine learning (ML) model that outputs the parameter;
predicting a PRC state and a reservoir drift using the system properties; and
mitigating PRC degradation associated with the reservoir drift by switching from the PRC to a computation framework, and the computation framework calculates the parameter using the ML model.

13. The method of claim 12 further comprising:
estimating the system properties offline for nominal operation by comparing between an input and a read-out from the PRC, the nominal operation associated with a vehicle application; and
identifying characteristics of the reservoir drift from changes among the system properties.

14. The method of claim 12, wherein predicting the PRC state further includes:
computing a direct measurement of the system properties online while a vehicle travels within the vehicle environment; and
calculating the reservoir drift using the direct measurement.

15. The method of claim 12, wherein predicting the PRC state further includes:
computing the parameter for the task online using the computation framework, and the computation framework is one of a vehicle PRC, a reservoir model on a graphics processing unit (GPU), and the reservoir model running on an application-specific integrated circuit (ASIC); and
comparing the parameter outputted from the PRC with that from the computation framework.

16. The method of claim 15 further comprising:
comparing a first forecast horizon (FH) of the PRC using a known input for the task with a second FH for the task using the computation framework; and
the computation framework includes physical substrates for the reservoir model that are different from the PRC.

17. The method of claim 12, wherein mitigating the PRC degradation further includes:
identifying a first subspace of the PRC having the reservoir drift and a second subspace lacking the reservoir drift, wherein an output from the first subspace has a degradation weight that is increased from the second subspace; and
switching to the computation framework for the first subspace.

18. The method of claim 12 further comprising:
training the computation framework by comparing an output signal from an output layer of the PRC with a corresponding input signal from an input layer, wherein the input signal excites the system properties for the vehicle environment;
computing the PRC state by combining predictions from the computation framework that is one of a vehicle PRC, a reservoir model on a GPU, and a reservoir computer running on an ASIC; and
identifying characteristics of the reservoir drift when the output signal deviates from an operating range associated with the predictions.

19. The method of claim 18, wherein mitigating the PRC degradation further includes:
tuning variables of the PRC using feedback from one of the operating range and the system properties.

20. The method of claim 12, wherein:
the reservoir drift is one of a coherence of a quantum state collapsing from an environmental perturbation, a leak occurring in a fluidic array, and the system properties deviating from an operating range;
the system properties are one of a forecast horizon, an echo state, a Lyapunov coefficient, feature separability, non-linearity, and memory;
the computation framework is one of a vehicle PRC, a reservoir model on a GPU, a reservoir computer running on an ASIC, an ASIC, and the GPU; and
the parameter is associated with computations as a time-series and the task is associated with a linear-dynamical system.
